(19) United States
(12) Patent Application Publication
(10) Pub. No.: US 2025/0389664 A1
(43) Pub. Date: Dec. 25, 2025

(54) SAMPLE ANALYSIS METHOD USING RAMAN SPECTROSCOPY AND ELECTRONIC DEVICE

(71) Applicant: Samsung Display Co., LTD., Yongin-si (KR)

(72) Inventors: Wang Lim CHOI, Yongin-si (KR); Man Jae PARK, Yongin-si (KR); Go Eun YUN, Yongin-si (KR)

(21) Appl. No.: 19/203,931

(22) Filed: May 9, 2025

(30) Foreign Application Priority Data
Jun. 20, 2024 (KR) 10-2024-0080266

(51) Int. Cl. G01N 21/65

(52) U.S. Cl. CPC G01N 21/65

(57) ABSTRACT

A sample analysis method using Raman spectroscopy and an electronic device are provided. The sample analysis method includes a plurality of unit analysis steps (e.g., acts or tasks) including changing a plurality of positions of the sample along an adjustment direction, calculating a plurality of peak intensities, each from a Raman spectrum at one of the different plurality of positions along the adjustment direction of the sample, in which a Raman spectrum having the greatest peak intensity is obtained when the sample is arranged at a first position, determining the first position as a measurement reference position of the sample, applying a light to the sample when the sample is arranged at the measurement reference position, and analyzing the characteristic of the sample based on Raman scattered light generated as the light is provided to the sample.

This application claims priority to and the benefit of Korean Patent Application No. 10-2024-0080266, filed on Jun. 20, 2024, in the Korean Intellectual Property Office, the entire disclosure of which is incorporated by reference herein.

### BACKGROUND

### 1. Field

One or more aspects of embodiments of the present disclosure relate to a sample analysis method using Raman spectroscopy and an electronic device.

### 2. Description of the Related Art

Optical measurement equipment methodologies are utilized in various industrial fields, such as the manufacturing and/or processing of semiconductors. These optical measurement equipment methodologies involve applying light to a target sample and analyzing characteristics related to the sample based on interaction between the applied light and the sample. For example, light reflected by the sample contains information regarding characteristics of the target sample as a result of this interaction. To evaluate or enhance the reliability of the optical measurement equipment, it is necessary or desired to minimize or reduce the extent or risk of distortion of the information carried by the light provided by the optical measurement equipment.

### SUMMARY

One or more aspects of embodiments of the present disclosure are directed toward a sample analysis method using Raman spectroscopy and an electronic device, with improved sample analysis reliability.

One or more aspects of embodiments of the present disclosure are directed toward a sample analysis method using Raman spectroscopy and an electronic device, in which non-destructive analysis for a sample may be performed and a characteristic related to a sample's internal structure may be accurately and closely analyzed.

Additional aspects will be set forth in part in the description which follows and, in part, will be apparent from the description, or may be learned by practice of the presented embodiments of the disclosure.

According to one or more embodiments of the present disclosure, a method may be a sample analysis method that may include a plurality of unit analysis steps (e.g., acts or tasks) including a unit analysis step (e.g., act or task) of analyzing a characteristic of a sample for an analysis target area. In one or more embodiments, the plurality of unit analysis steps (e.g., acts or tasks) may include changing a plurality of positions of the sample along an adjustment direction, calculating a plurality of peak intensities, each peak intensity from a Raman spectrum at one of the plurality of (e.g., different) positions along the adjustment direction of the sample, in which a Raman spectrum that has a greatest peak intensity among the plurality of peak intensities is obtained when the sample is arranged at a first position, determining the first position as a measurement reference position of the sample (e.g., by determining the greatest peak intensity from the plurality of peak intensities), applying a light to the sample when the sample is arranged at the measurement reference position, and analyzing the characteristic of the sample based on Raman scattered light generated as the light is provided to the sample.

According to one or more embodiments, in the plurality of unit analysis steps (e.g., acts or tasks), the measurement reference position may be updated according to a position of the analysis target area in the sample.

According to one or more embodiments, in the plurality of unit analysis steps (e.g., acts or tasks), as the measurement reference position is determined, a factor for obtaining the Raman spectrum may be updated.

According to one or more embodiments, the factor may include at least one selected from among (e.g., one or more of) an intensity of the light, an application time of the light, and a number of times the light is applied.

According to one or more embodiments, in the plurality of unit analysis steps (e.g., acts or tasks), a position of the analysis target area for the light may be tracked.

According to one or more embodiments, the characteristic may include at least one selected from among (e.g., one or more of) a stress of the sample, a structure of the sample, and a phase of the sample.

According to one or more embodiments, the sample may be a light emitting diode sample or an organic layer sample.

According to one or more embodiments, changing the plurality of positions may include changing a height of the sample by a stage on which the sample is arranged, (e.g., the sample may be on the stage and changing the plurality of positions may include changing a (e.g., plurality of) height(s) of the stage). The adjustment direction may be parallel to a direction in which the light is provided.

According to one or more embodiments, the adjustment direction may be a depth direction of the sample based on a direction in which the light is provided.

According to one or more embodiments, the plurality of unit analysis steps (e.g., acts or tasks) may include a first plurality of unit analysis steps (e.g., acts or tasks) including at least analyzing a characteristic of the sample in a first analysis target area, and a second plurality of unit analysis steps (e.g., acts or tasks) including at least analyzing a characteristic of the sample in a second analysis target area. The first analysis target area and the second analysis target area may be spaced and/or apart (e.g., spaced apart or separated) from each other along the adjustment direction.

According to one or more embodiments, the second plurality of unit analysis steps (e.g., acts or tasks) may be performed after the first plurality of unit analysis steps (e.g., acts or tasks), and the measurement reference position may be updated in the second plurality of unit analysis step.

According to one or more embodiments, changing the plurality of positions may include arranging the sample at the first position, and arranging the sample at a second position different from the first position. When the sample is arranged at the first position, a first focus line of the light may overlap the analysis target area (e.g., an analysis target area at the first position). When the sample is arranged at the second position, a second focus line of the light may be spaced and/or apart (e.g., spaced apart or separated) from the first focus line.

According to one or more embodiments, a peak intensity of a Raman spectrum obtained at the second position (e.g., when the sample is arranged at the second position, the obtained peak intensity of the Raman spectrum) may be less than a peak intensity of a Raman spectrum obtained at the first position (e.g., the obtained peak intensity of the Raman spectrum when the sample is arranged at the first position).

According to one or more embodiments, changing the plurality of positions may further include arranging the sample at a third position different from the first position and the second position. When the sample is arranged at the third position, a third focus line of the light may be spaced and/or apart (e.g., spaced apart or separated) from the first focus line, and the third focus line may be between the first focus line and the second focus line.

According to one or more embodiments of the disclosure, a method may be a sample analysis method that may include providing a light to a sample including a first analysis target area and a second analysis target area that are spaced and/or apart (e.g., spaced apart or separated) in one direction, and analyzing a characteristic of the sample based on Raman scattered light generated as the light is provided to the sample. Analyzing the characteristic of the sample may include a first plurality of unit analysis steps (e.g., acts or tasks) including at least analyzing the characteristic of the sample in the first analysis target area, and a second plurality of unit analysis steps (e.g., acts or tasks) including at least analyzing the characteristic of the sample in the second analysis target area. Each of the first plurality of unit analysis steps (e.g., acts or tasks) and the second plurality of unit analysis steps (e.g., acts or tasks) may include changing a plurality of positions of the sample along the one direction.

According to one or more embodiments of the present disclosure, an electronic device, may include: a processor configured to provide input image data; a display device configured to display an image based on the input image data, the display device including a light emitting diode analyzed by the sample analysis method; and a power supply configured to supply power to the display device.

According to one or more embodiments of the disclosure, a sample analysis method using Raman spectroscopy and an electronic device, with improved sample analysis reliability may be provided.

According to one or more embodiments of the disclosure, a sample analysis method using Raman spectroscopy and an electronic device, in which non-destructive analysis for a sample may be performed and a characteristic related to a sample internal structure may be closely analyzed may be provided.

### BRIEF DESCRIPTION OF THE DRAWINGS

The accompanying drawings are included to provide a further understanding of the preceding and other aspects, features, and advantages of certain embodiments of the present disclosure, and they are incorporated in and constitute a part of this specification. The drawings illustrate example embodiments that will become more apparent by describing in further detail embodiments thereof with reference to the accompanying drawings. In the drawings:

FIG. 1 is a schematic diagram illustrating a Raman spectroscopy system according to one or more embodiments of the present disclosure;

FIG. 2 is a schematic diagram illustrating an operation of setting a focus of light applied to a sample according to one or more embodiments of the present disclosure;

FIG. 3 is a flowchart illustrating a sample analysis method using Raman spectroscopy according to one or more embodiments of the present disclosure;

FIG. 4 is a flowchart illustrating a unit analysis step (e.g., act or task) included in a sample analysis method using Raman spectroscopy according to one or more embodiments of the present disclosure;

FIGS. 5, 6, and 8 are schematic diagrams illustrating some steps (e.g., acts or tasks) of a sample analysis method according to one or more embodiments of the present disclosure; and

FIG. 7 is a graph illustrating a difference in relative intensity of a Raman spectrum with respect to a Raman shift.

FIG. 9 is a schematic block diagram illustrating an electronic device including a display device according to one or more embodiments of the present disclosure.

FIG. 10 is a schematic diagram illustrating an example where the electronic device of FIG. 9 is implemented as a smartphone.

FIG. 11 is a schematic diagram illustrating an example where the electronic device of FIG. 9 is implemented as a tablet computer.

### DETAILED DESCRIPTION

The present disclosure may be modified in one or more suitable manners and have one or more suitable forms. Therefore, the following reference to one or more embodiments, examples of which are illustrated in the accompanying drawings, is will described in more detail in the specification. However, it should be understood that the present disclosure is not intended to be limited to the disclosed specific forms, and the present disclosure includes all modifications, equivalents, and substitutions within the spirit and technical scope of the disclosure. The one or more embodiments are provided so that the present disclosure is thorough and complete, and fully conveys the scope of the present disclosure to those skilled in the art.

Terms of “first”, “second”, and/or the like may be used to describe one or more suitable components, but the components should not be limited by the terms. The terms are used only for the purpose of distinguishing one component from another component. For example, without departing from the scope of the disclosure, a first component may be referred to as a second component, and similarly, a second component may also be referred to as a first component. In the following description, the singular expressions such as “a,” “an,” and “the” include plural expressions unless the context clearly dictates otherwise.

It should be understood that in the present application, the terms “include”, “includes”, “including”, “have”, “has”, “having”, “comprises”, “comprising”, “comprise”, and/or the like are used to specify that there is a feature, a number, a step (e.g., act or task), an operation, a component, a part, and/or a (e.g., any suitable) combination thereof described in the specification, but these terms do not exclude a possibility of the presence or addition of one or more other features, numbers, steps (e.g., acts or tasks), operations, components, parts, and/or one or more (e.g., any suitable) combinations thereof in advance.

In some embodiments, a case where a portion of a component, a layer, an area, a plate, and/or the like is referred to as being “on” or “connected to” another portion, it includes not only a case where the portion is “directly on” or “directly connected to” another portion, but also a case where there is further another portion between the portion and the other portion. In some embodiments, in the present specification, if (e.g., when) a portion of a component, a layer, an area, a plate, and/or the like is formed on another portion, a forming direction is not limited to an upper direction but includes forming the portion on a side surface or in a lower direction. In contrast, when a portion of a component, a layer, an area, a plate, and/or the like is formed “under” another portion, this includes not only a case where the portion is “directly beneath” another portion but also a case where there is further another portion between the portion and the other portion.

Each of the features of the one or more embodiments of the present disclosure may be combined or combined with each other, in part or in whole, and technically one or more suitable interlocking and driving are possible. Each embodiment may be implemented independently of each other or may be implemented together in an association.

In the drawings, the same reference numbers indicate the same components throughout the specification, and thus redundant descriptions thereof will not be provided. Sizes of elements in the drawings may be exaggerated for convenience of explanation. In other words, because sizes and thicknesses of components in the drawings are arbitrarily illustrated for convenience of explanation, the following embodiments are not limited thereto.

Unless otherwise defined, all chemical names, technical and scientific terms, and terms defined in common dictionaries should be interpreted as having meanings consistent with the context of the related art, and should not be interpreted in an ideal or overly formal sense.

As used herein, the term “and/or” includes any and all combinations of one or more of the associated listed items. Expressions such as “at least one of,” “one of,” “selected from,” and “selected from among,” when preceding a list of elements, modify the entire list of elements and do not modify the individual elements of the list. For example, throughout the disclosure, the expression “at least one of a, b or c” indicates only a, only b, only c, both (e.g., simultaneously) a and b, both (e.g., simultaneously) a and c, both (e.g., simultaneously) b and c, all of a, b, and c, or variations thereof.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

Spatially relative terms, such as “beneath,” “below,” “lower,” “above,” “upper,” “bottom,” “top,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the device in the drawings is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

In this context, “consisting essentially of” indicates that any additional components will not materially affect the chemical, physical, optical or electrical properties of the semiconductor film.

Further, in this specification, the phrase “on a plane” indicates viewing a target portion from the top, and the phrase “on a cross-section” indicates viewing a cross-section formed by vertically cutting a target portion from the side.

The disclosure relates to a sample analysis method using Raman spectroscopy and an electronic device. Hereinafter, a sample analysis method using Raman spectroscopy and an electronic device according to one or more embodiments is described with reference to the attached drawings.

### Raman Spectroscopy System

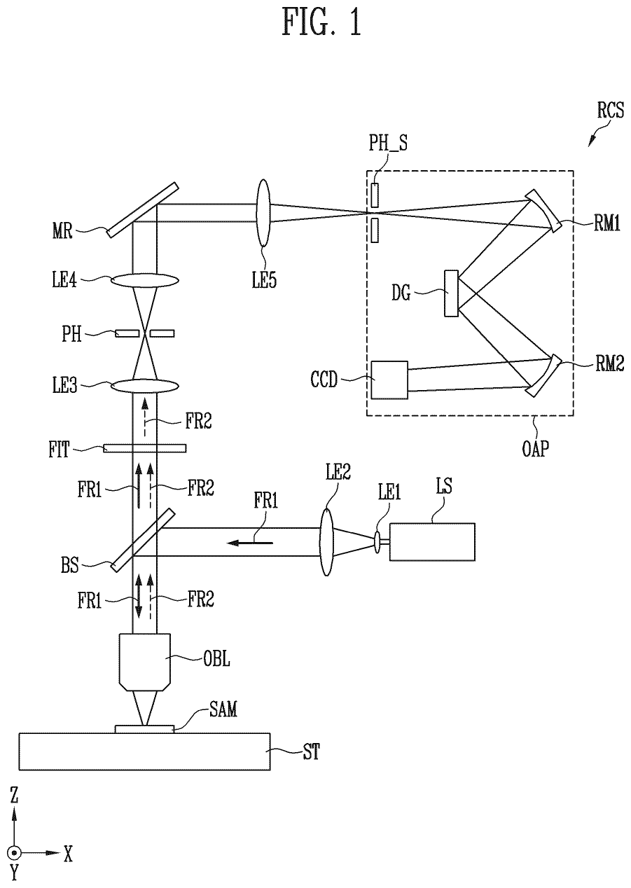

FIG. 1 is a schematic diagram illustrating a Raman spectroscopy system according to one or more embodiments. FIG. 1 shows a plurality of devices and an analysis target sample SAM for implementing the Raman spectroscopy system (for example, Raman spectroscopy). In FIG. 1 a light path is shown as a solid line between each of configurations.

According to one or more embodiments, a sample analysis method using Raman spectroscopy is disclosed as a method of analyzing the sample SAM based on (e.g., utilizing) optical information.

Raman spectroscopy is one of optical measurement methods of applying light such as a laser to the sample SAM which is an analysis target, and analyzing a characteristic (e.g., a stress, a structure, a phase, and/or the like) of the sample SAM based on Raman scattered light that is reflected or scattered from or by the sample SAM in response to (e.g., interacting with) the applied light.

Referring to FIG. 1, the Raman spectroscopy system RCS (or an optical measurement device) may include a light source part LS, a first lens LE1, a second lens LE2, a beam splitter BS, an objective lens OBL, a stage ST, the sample SAM, a filter part FIT, a third lens L3, a pin-hole part PH, a fourth lens L4, a mirror part MR, a fifth lens L5, and an optical analysis part OAP. The optical analysis part OAP may include a first reflection part RM1, a second reflection part RM2, a diffraction grating part DG, and an optical inspection part CCD.

The light source part LS is configured to output light. The light source part LS may generate light, and the generated light may pass through the first lens LE1 and the second lens LE2. The light provided by the light source part LS may be a laser and/or the like. For example, a wavelength of the laser may be 400 nanometer (nm) to 800 nm, but the disclosure is not limited thereto.

The light provided by the light source part LS may include a light component having a first frequency FR1. In FIG. 1, the light including the light component having the first frequency FR1 is indicated by a solid (e.g., double-headed) arrow. The first frequency FR1 may be an exciting (e.g., excitation) frequency.

The first lens LE1 may be arranged between the second lens LE2 and the light source part LS. The first lens LE1 may expand the light provided from the light source part LS.

The second lens LE2 may be arranged between the beam splitter BS and the first lens LE1 based on a movement path of light. The second lens LE2 may collimate the light provided from the first lens LE1.

The beam splitter BS may be arranged in a front surface of the second lens LE and may be arranged between the objective lens OBL and the filter part FIT. The beam splitter BS may receive light provided from the second lens LE2 and direct the provided light to the objective lens OBL.

The objective lens OBL may be arranged between the beam splitter BS and the sample SAM. The objective lens OBL may focus the light provided from the beam splitter BS onto the sample SAM.

For example, the light provided by the light source part LS may include the light component having the first frequency FR1, and may be provided to the sample SAM through the first lens LE1, the second lens LE2, the beam splitter BS, and the objective lens OBL.

The stage ST may form a base for arranging (e.g., providing) the sample SAM. The stage ST may be arranged on one plane based on an x-direction x and a y-direction y, and may be adjacent to the sample SAM along a z-direction z. The z-direction z may be a thickness direction of the stage ST. The z-direction z may be a thickness direction of the sample SAM. A plan view may be a view with respect to the z-direction, providing a top-down perspective of the stage and sample arrangement.

The sample SAM may be arranged on the stage ST and may be arranged in line with (e.g., under) the objective lens OBL.

The sample SAM may be a measurement target using a Raman spectrometer. The sample SAM may be configured of one or more suitable objects. For example, the sample SAM may be a light emitting diode sample including a plurality of layers. In this case, using the sample analysis method using Raman spectroscopy according to one or more embodiments, information on a stress generated in a light emitting diode may be obtained, and information on a deformation state of layers of the light emitting diode may also be obtained.

However, the disclosure is not limited thereto. In another example, the sample SAM may be an organic layer sample for analyzing a cure profile.

The sample SAM may receive light provided from the objective lens OBL and output reflected light, Rayleigh scattered light, and/or Raman scattered light. For example, an interaction between the first frequency FR1 of the light provided to the sample SAM and a natural frequency of a molecular structure of the sample SAM may result in or form a Raman scattering reaction, and thus the Raman scattered light may be reflected (e.g., output).

The Rayleigh scattered light and/or the Raman scattered light may be reflected (e.g., output) toward an upper portion (for example, the objective lens OBL and the beam splitter BS) opposite to (e.g., facing) the sample SAM. The Rayleigh scattered light may include the light component having the first frequency FR1, and the Raman scattered light may include a light component having a second frequency FR2 different from the first frequency FR1.

In FIG. 1, light including the light component having the second frequency FR2 is indicated by a dotted arrow. The second frequency FR2 may be a Raman frequency.

The filter part FIT may be arranged between the beam splitter BS and the third lens LE3. The filter part FIT may receive light applied through the objective lens OBL and the beam splitter BS as light reflected (e.g., provided) from the sample SAM.

The filter part FIT may selectively transmit light having one frequency. The filter part FIT may block the light component having the first frequency FR1 and transmit the light component having the second frequency FR2. Accordingly, light provided to the optical analysis part OAP may include the light component having the second frequency FR2 without including the light component having the first frequency FR1.

The filter part FIT may be an edge pass filter or a notch filter. However, the disclosure is not limited to a specific example. 1

The third lens LE3 may be arranged between the filter part FIT and the pin-hole part PH. The third lens LE3 may focus light provided from the filter part FIT onto the pin-hole part PH.

The pin-hole part PH may be arranged between the third lens LE3 and the fourth lens LE4. The pin-hole part PH may include a confocal pinhole structure. The pin-hole part PH may provide light provided from the third lens LE3 to the fourth lens LE4.

The fourth lens LE4 may be arranged between the pin-hole part PH and the mirror part MR. The fourth lens LE4 may provide light provided from the pin-hole part PH to the mirror part MR.

The mirror part MR may be arranged between the fourth lens LE4 and the fifth lens LE5 based on the light path. The mirror part MR may provide light provided from the fourth lens LE4 to the fifth lens LE5.

The fifth lens LE5 may be arranged between the mirror part MR and the optical analysis part OAP. The fifth lens LE5 may provide light provided from the mirror part MR to the optical analysis part OAP.

For example, the light provided by the filter part FIT may include the light component having the second frequency FR2, and may be provided to the optical analysis part OAP through the third lens LE3, the pin-hole part PH, the fourth lens LE4, the mirror part MR, and the fifth lens LE5.

The optical analysis part OAP may be configured to analyze the characteristic of the sample SAM based on the reflected (e.g., applied) Raman scattered light including the second frequency FR2.

According to one or more embodiments, the optical analysis part OAP may include an optical pin-hole part PH_S, a first reflection part RM1, a second reflection part RM2, the diffraction grating part DG, and the optical inspection part CCD.

The optical pin-hole part PH_S may receive light provided from the fifth lens LE5 (for example, the light provided by the filter part FIT). The fifth lens LE5 may focus light provided from the mirror part MR onto the optical pin-hole part PH_S.

The first reflection part RM1 may receive light provided from the optical pin-hole part PH_S, and may reflect applied light so that the light directs the diffraction grating part DG. The first reflection part RM1 may be a concave mirror member including a reflective material.

The diffraction grating part DG may diffract light provided from the first reflection part RM1 in another direction. The diffraction grating part DG may include a diffraction grating structure. The diffraction grating part DG may direct applied light to the second reflection part RM2.

The second reflection part RM2 may receive light from the diffraction grating part DG, and the second reflection part RM2 may direct the light provided from the diffraction grating part DG to the optical inspection part CCD. The second reflection part RM2 may be a concave mirror member including a reflective material.

The optical inspection part CCD may receive light from the second reflection part RM2, obtain optical information of the sample SAM based on the reflected (e.g., provided) light, and analyze the characteristic of the sample SAM based on the optical information of (e.g., reflected or received from) the sample SAM.

For example, the optical inspection part CCD may be a charge coupled device (CCD) camera member. However, the disclosure is not necessarily limited thereto. The optical inspection part CCD may include one or more suitable devices that may convert an optical signal into an electrical signal.

The optical inspection part CCD may receive light including the Raman scattered light as light including the light component having the second frequency FR2, and analyze the characteristic (e.g., the stress of the target, the structure of the target, the phase of the target, and/or the like) of the sample SAM based on the Raman scattered light.

For example, the optical inspection part CCD may calculate a Raman spectrum using the received Raman scattered light.

The calculated Raman spectrum may represent a light intensity for each frequency difference of the Raman scattered light shifted with respect to a frequency of the Rayleigh scattered light (or a frequency of the initial light L applied to the sample SAM). For example, the optical inspection part CCD may calculate an intensity of each frequency of the received Raman scattered light and, based on this, calculate a light intensity for a Raman shift. The Raman shift may represent a difference between an initial frequency of the light L and the frequency of the Raman scattered light if (e.g., when) applied to the sample SAM. The calculated Raman spectrum may be shown as a graph of a light intensity versus the Raman shift(s). For example, the Raman spectrum may be shown as a graph where a frequency value of the Raman shift(s) (for example, expressed in a unit of inverse centimeters (cm⁻¹) (e.g., wave number)) is shown on an x-axis and a relative intensity corresponding to each frequency value is shown on a y-axis.

The calculated Raman spectrum may include one or more suitable characteristic information datum of the sample SAM. For example, a stress state inside the sample SAM may be identified using a peak position of the Raman spectrum. When a value of the peak position of the Raman spectrum changes (e.g., moves), it may be understood that a stress exists inside the sample SAM. For example, if (e.g., when) a compressive stress exists inside the sample SAM, the value or position of the peak may change (e.g., be moved) in a high energy direction (for example, a high frequency direction), and if (e.g., when) a tensile stress exists inside the sample SAM, the position of the peak may change (e.g., be moved) in a low energy direction (for example, a low frequency direction). In some embodiments, a structure (for example, a crystal structure) in the sample SAM may be analyzed using an intensity of the peak. In some embodiments, uniformity and a degree of combination of the sample SAM may be analyzed using a width of the peak. For example, if (e.g., when) the width of the peak is analyzed to be relatively wide, it may be analyzed that non-uniformity is large and many defects exist in the sample SAM.

Based on this Raman analysis method, non-destructive analysis of the sample SAM may be possible.

However, if (e.g., when) optical information of the Raman scattered light reflected by (e.g., provided from) the sample SAM is not clearly obtained, a concern that the characteristic information of the analyzed sample SAM may be distorted may exist.

For example, along a depth direction (for example, the z-direction z) of the sample SAM, the intensity of the light applied to generate the Raman scattered light may be reduced. For example, a possibility or risk may exist that information such as an intensity of the Raman scattered light may be changed by another factor other than the characteristic (an internal stress, an internal structure, and/or the like) of the sample SAM.

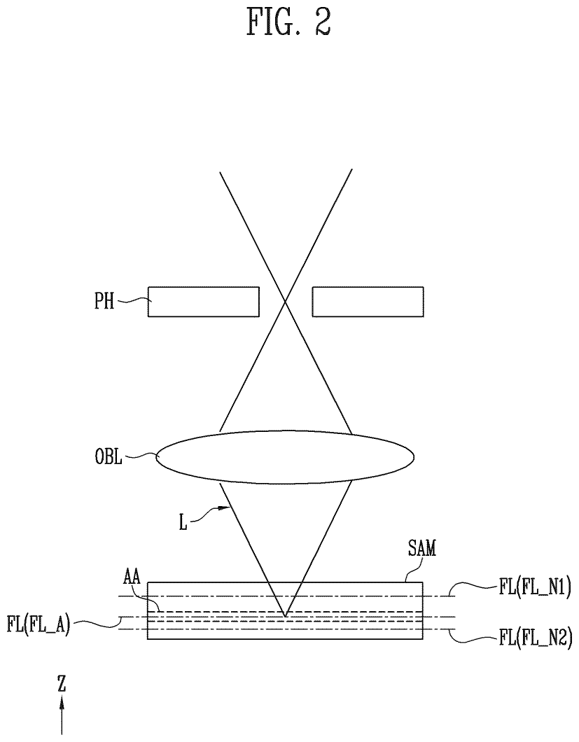

However, according to one or more embodiments, a position of the sample SAM may be changed so that focus of the light applied to each of the analysis target areas of the sample SAM may be formed at an improved or optimized position. This process is described in more detail herein with reference to FIG. 2.

### Light Focusing Objective Lens

FIG. 2 is a schematic diagram illustrating an operation of setting a focus of the light applied to a sample according to one or more embodiments. A content of the disclosure that may overlap the preceding description of features (e.g., content) is briefly described in more detail or is not repeated.

For convenience of description, FIG. 2 schematically shows more detail only for a structure in which the objective lens OBL focuses light L, a structure in which the pin-hole portion PH receives the Raman scattered light, and a structure in which the sample SAM receives the light L, and descriptions of other components are not included in FIG. 2.

Referring to FIG. 2, the objective lens OBL may provide the light L provided from the light source part LS to the sample SAM. The light L may be focused by the objective lens OBL and provided to a portion or partial area of the sample SAM (e.g., an analysis target area).

According to one or more embodiments, the objective lens OBL may be arranged on the sample SAM based on the z-direction z. Accordingly, a focus position of the light L may be arranged on a focus line FL based on the z-direction z.

According to one or more embodiments, a position of the focus line FL may be changed for each position of the sample SAM. For example, corresponding to an analysis target area AA that is a portion of the sample SAM, the position along the z-direction z of the sample SAM may be changed, and thus the position of the focus line FL may be formed to correspond to (for example, overlap with) the analysis target area AA of the focus line FL.

According to one or more embodiments, the position along the z-direction z of the sample SAM may be changed by a position of the stage ST rising or falling along the z-direction z.

According to one or more embodiments, the peak intensity of the Raman spectrum for the analysis target area AA may have a relatively great intensity if (e.g., when) measured based on the focus line FL formed at a suitable focus line position FL_A. For example, if (e.g., when) the light L is applied to the analysis target area AA based on the focus line FL formed at non-suitable focus line positions FL_N1 and FL_N2, the peak intensity of the Raman spectrum may be relatively small.

For example, the focus position may be defined so that the first non-suitable focus line position FL_N1 is closer (e.g., more adjacent) to the objective lens OBL than the suitable focus line position FL_A. The focus position may be defined so that the second non-suitable focus line position FL_N2 is further away from the objective lens OBL than the suitable focus line position FL_A. Because the first and second non-suitable focus line positions FL_N1 and FL_N2 are spaced and/or apart (e.g., spaced apart or separated) compared to the suitable focus line position FL_A (which is specified at a relatively suitable position), or do not overlap the analysis target area AA, the peak intensity of the Raman spectrum measured in the analysis target area AA using the light L in which the focus line FL is formed at the first and second non-suitable focus line positions FL_N1 and FL_N2 may be relatively small.

According to one or more embodiments, if (e.g., when) the peak intensity of the Raman spectrum is measured to be small, a factor other than the characteristic of the sample SAM itself may act as an interspersion (e.g., undesired contribution) in a measurement result. According to one or more embodiments, the position of the focus line FL may be tracked and improved or optimized according to the analysis target area AA. Accordingly, a difference in intensity of the light L applied for each position of the sample AA along the z-direction z may be compensated, and as optical information of the light L is compensated, reliability of the optical information of the Raman light intensity may be evaluated or reconsidered, and ultimately the characteristic of the sample SAM may be identified more closely.

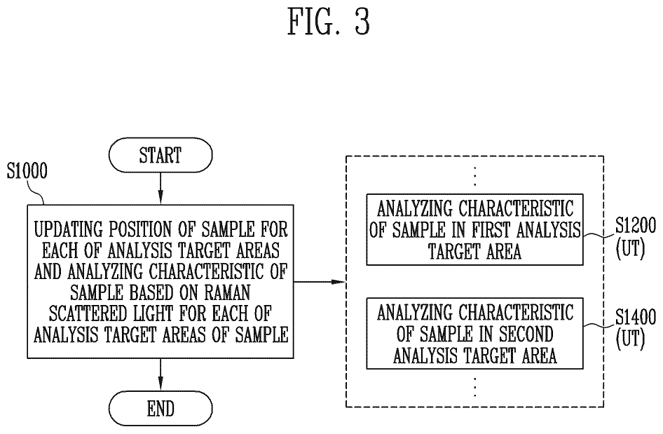

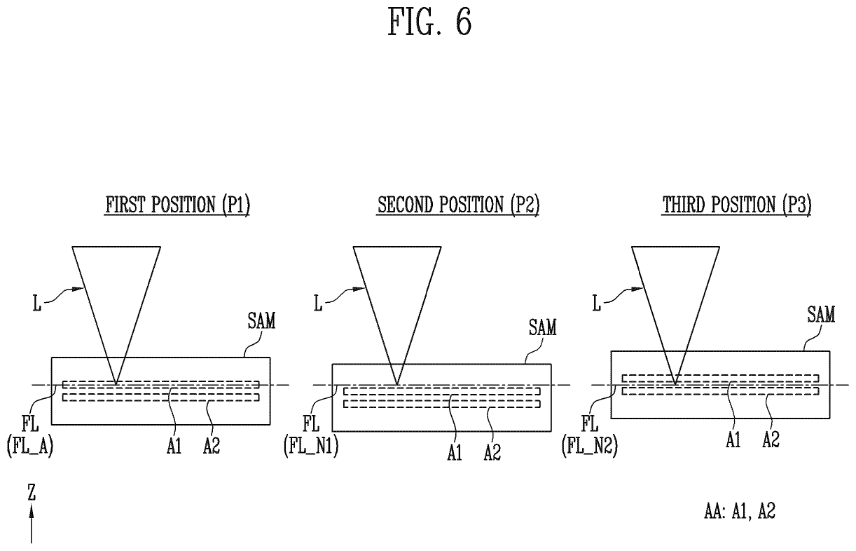

Hereinafter, a sample analysis method using Raman spectroscopy is described with further reference to FIGS. 3 to 8. A content of the disclosure that may overlap the preceding description of features (e.g., content) is briefly described in more detail or is not repeated.

### Methods of Sample Analysis

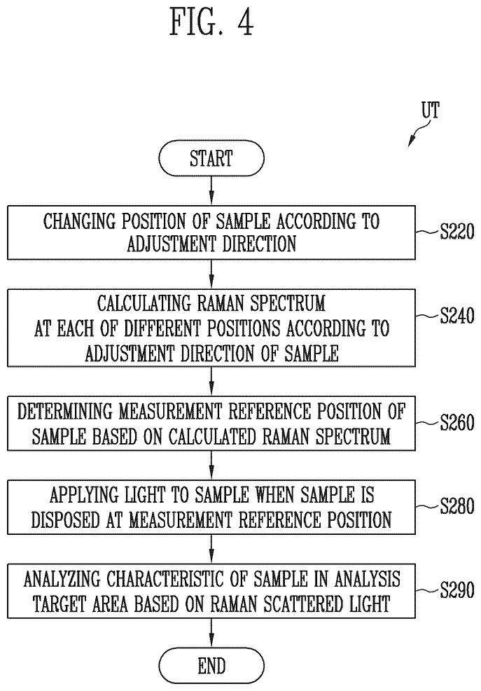

FIG. 3 is a flowchart illustrating a sample analysis method using Raman spectroscopy according to one or more embodiments. FIG. 4 is a flowchart illustrating a unit analysis step (e.g., act or task) included in a sample analysis method using Raman spectroscopy according to one or more embodiments.

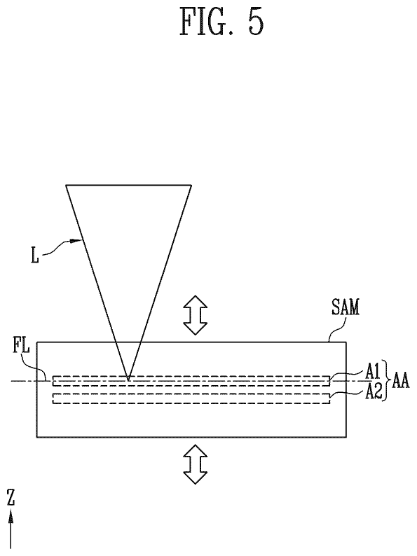

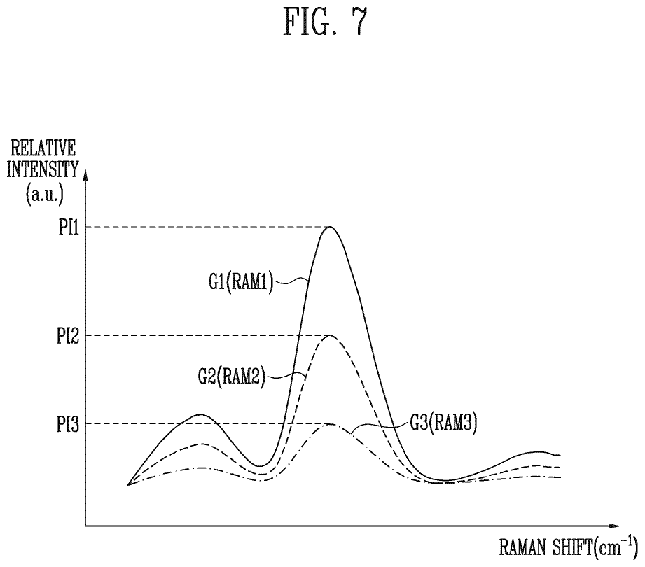

FIGS. 5, 6, and 8 are schematic diagrams respectively illustrating some steps (e.g., acts or tasks) of a sample analysis method according to one or more embodiments. FIG. 7 is a graph illustrating a difference in relative intensity of a Raman spectrum with respect to a Raman shift.

Referring to FIG. 3, the sample analysis method using the Raman spectroscopy system according to one or more embodiments may include updating the position of the sample for each analysis target area and analyzing the characteristic of the sample based on the Raman scattered light for each analysis target area of the sample (S1000).

According to the sample analysis method using the Raman spectroscopy system according to one or more embodiments, in each of the unit analysis steps (e.g., acts or tasks) UT, the position (for example, a measurement reference position) of the sample SAM for the light L applied to the sample SAM may be updated for each of analysis target area AA of the sample SAM. For example, in each of the unit analysis steps (e.g., acts or tasks) UT, for each position of the analysis target area AA of the sample SAM, the position of the analysis target area AA for the light L applied to the sample SAM may be tracked. Accordingly, data for analyzing the sample SAM may be updated based on the updated position of the sample SAM (for example, the measurement reference position).

Accordingly, an extent or risk that optical information for forming the Raman spectrum is distorted may be reduced, and reliability of analysis of the sample SAM may be improved.

According to one or more embodiments, the sample analysis method using the Raman spectroscopy system may include the unit analysis steps (e.g., acts or tasks) UT in which factors for obtaining the measurement reference position and the Raman spectrum of the sample SAM are updated.

For example, the unit analysis steps (e.g., acts or tasks) UT may be performed for each of the analysis target areas AA. For convenience of description, the sample analysis method is described based on steps (e.g., acts or tasks) of sequentially analyzing first and second analysis target areas (e.g., A1 and A2) which are separate analysis target areas AA of the sample SAM.

For example, according to one or more embodiments, after the characteristic of the sample SAM is analyzed based on the Raman spectrum for the first analysis target area A1 (which is one of the analysis target areas AA), the characteristic of the sample SAM may be analyzed based on the Raman spectrum for the second analysis target area A2 (which is one of the analysis target areas AA), and additional unit analysis step(s) (e.g., act(s) or task(s)) UT may be performed before or after the unit analysis steps (e.g., acts or tasks) UT of analyzing the first and second analysis target areas A1 and A2. According to one or more embodiments, the first analysis target area A1 and the second analysis target area A2 may be spaced and/or apart (e.g., spaced apart or separated) from each other along an adjustment direction of the sample SAM.

According to one or more embodiments, after the unit analysis step (e.g., act or task) UT for analyzing the characteristic of the sample SAM for the first analysis target area A1 is performed, the unit analysis step (e.g., act or task) UT for analyzing the characteristic of the sample SAM for the second analysis target area A2 may be performed.

Referring to FIG. 4, each of the unit analysis steps (e.g., acts or tasks) UT included in the sample analysis method using the Raman spectroscopy system according to one or more embodiments may include:
changing a plurality of positions of the sample according to the adjustment direction (S220);
calculating a plurality of peak intensities, each peak intensity from a Raman spectrum at one of each of the plurality of different positions according to the adjustment direction of the sample (S240), wherein a Raman spectrum having a greatest peak intensity among the plurality of peak intensities is obtained when the sample is at a first position;
determining the first position as a measurement reference position of the sample based on the greatest calculated peak intensity of the Raman spectrum (S260);
applying light to the sample when the sample is arranged at the measurement reference position (S280); and
analyzing the characteristic of the sample based on the Raman scattered light (S290).

Referring to FIGS. 4 to 6 in conjunction with FIG. 1, changing the position of the sample according to the adjustment direction (S220) may be performed.

In this step (e.g., act or task) S220, the light L may be applied to the sample SAM, and the position of the sample SAM may be changed. In this step (e.g., act or task) S220, the position of the sample SAM may be changed along the adjustment direction. According to one or more embodiments, the position of the sample SAM along the adjustment direction may be adjusted as the position (for example, a height) of the stage ST changes. According to one or more embodiments, the position of the sample SAM may be moved in an upward direction, and/or the position of the sample SAM may be moved in a downward direction.

According to one or more embodiments, the adjustment direction may be the z-direction z. According to one or more embodiments, the adjustment direction may be parallel to a direction in which the light L is provided. According to one or more embodiments, the adjustment direction may be a depth direction of the sample SAM. According to one or more embodiments, the adjustment direction may extend in a direction different from the focus line FL. For example, the adjustment direction may be normal (e.g., perpendicular) to the focus line FL.

In this step (e.g., act or task) S220, the focus line FL may be formed adjacent to the first analysis target area A1. For example, the focus line FL may overlap the first analysis target area A1, may be formed above the first analysis target area A1, and may be formed below the first analysis target area A1.

In this step (e.g., act or task) S220, the position of the sample SAM may be controlled or selected (e.g., changed), and thus the sample SAM may be arranged at a first position P1. When the sample SAM is arranged at the first position P1, the focus line FL may overlap the first analysis target area A1, and the focus line FL may be defined at a suitable position in order to analyze the sample SAM in the first analysis target area A1. When the sample SAM is arranged at the first position P1, the focus line FL may be arranged at the suitable focus line position FL_A.

In this step (e.g., act or task) S220, the position of the sample SAM may be adjusted (e.g., changed), and thus the sample SAM may be arranged at the second position P2. When the sample SAM is arranged at the second position P2, the focus line FL may be spaced from the suitable focus line position FL_A, and the focus line FL may be defined at a relatively non-suitable position in order to analyze the sample SAM in the first analysis target area A1. When the sample SAM is arranged at the second position P2, the focus line FL may be arranged at the first non-suitable focus line position FL_N1.

In this step (e.g., act or task) S220, the position of the sample SAM may be adjusted, and thus the sample SAM may be arranged at a third position P3. When the sample SAM is arranged at the third position P3, the focus line FL may be spaced from the suitable focus line position FL_A, and the focus line FL may be defined at a relative non-suitable position in order to analyze the sample SAM in the first analysis target area A1. When the sample SAM is arranged at the third position P3, the focus line FL may be arranged at the second non-suitable focus line position FL_N2.

According to one or more embodiments, a sequential relationship between a time point at which the sample SAM is arranged at the first position P1, a time point at which the sample SAM is arranged at the second position P2, and a time point at which the sample SAM is arranged at the third position P3 is not particularly limited.

Referring to FIGS. 4 to 7 in conjunction with FIG. 1, calculating the Raman spectrum at each different position according to the adjustment direction of the sample (S240) may be performed.

FIG. 7 shows relative intensity of Raman spectra calculated when the sample SAM is arranged at each of the first to third positions P1 to P3, and illustrates a relative intensity with respect to (e.g., for) a frequency value (inverse centimeter) of a Raman shift. A relative intensity represents a relative value (arbitrary unit (a.u.)) and represents a relationship between relative light intensities and Raman shifts of the Raman spectra.

In this step (e.g., act or task) S240, the light L may be applied to the sample SAM at each of changed positions of the sample SAM, and the Raman scattered light may be reflected by (e.g., provided from) the sample SAM. In this step (e.g., act or task) S240, the light source part LS may provide the light L that may be applied to the sample SAM through the objective lens OBL. The light L may be provided to the sample SAM through the first lens LE1, the second lens LE2, the beam splitter BS, and the objective lens OBL. The light L may be provided to the sample SAM based on the focus line FL. The Raman scattered light reflected (e.g., provided) by the sample SAM may pass through the filter part FIT and/or the like and may be provided to the optical analysis part OAP, and information on the Raman spectrum may be obtained based on the reflected (e.g., provided) Raman scattered light.

In this step (e.g., act or task) S240, if (e.g., when) the sample SAM is arranged at the first position P1, the light L forming the focus line FL at the suitable focus line position FL_A may be applied (e.g., provided) to the sample SAM, and a first Raman spectrum RAM1 having a first peak intensity PI1 may be calculated based on the output Raman scattered light.

In this step (e.g., act or task) S240, when the sample SAM is arranged at the second position P2, the light L forming the focus line FL at the first non-suitable focus line position FL_N1 may be applied (e.g., transmitted) to the sample SAM, and a second Raman spectrum RAM2 having a second peak intensity PI2 may be calculated based on the output Raman scattered light.

In this step (e.g., act or task) S240, when the sample SAM is arranged at the third position P3, the light L forming the focus line FL at the second non-suitable focus line position FL_N2 may be applied (e.g., provided) to the sample SAM. A third Raman spectrum RAM3 having a third peak intensity P13 may be calculated based on the output Raman scattered light.

In FIG. 7, the first Raman spectrum RAM1 is represented by a first graph G1, the second Raman spectrum RAM2 is represented by a second graph G2, and the third Raman spectrum RAM3 is represented by a third graph G3.

Referring to FIGS. 4 to 7 in conjunction with FIG. 1, determining the measurement reference position of the sample based on the peak intensities of the calculated Raman spectrum may be performed.

In this step (e.g., act or task) S260, the measurement reference position of the sample SAM may be determined based on the peak intensities of the Raman spectra obtained at each of different positions based on the adjustment direction of the sample SAM.

In this step (e.g., act or task) S260, the Raman spectrum having the greatest peak intensity may be determined by comparing peak intensities of each of the Raman spectra, and a position where the Raman spectrum having the greatest peak intensity may be determined as the measurement reference position.

For example, by comparing the first to third peak intensities PI1 to PI3 of the first to third Raman spectra RAM1 to RAM3, it may be determined that the first Raman spectrum RAM1 has the greatest peak intensity. Accordingly, the first position P1, which is the position where the first Raman spectrum RAM1 having the greatest peak intensity is measured, may be determined as the measurement reference position.

In one or more embodiments, the measurement reference position of the sample SAM may be determined, and different factors for calculating the Raman spectrum may be updated. For example, in order to calculate the Raman spectrum, one or more of the intensity of the light L, an application time of the light L, and the number of times the light L is applied to analyze the first analysis target area A1 may be properly set (or updated). These factors are desired or required to be set differently according to the position of the sample SAM. According to one or more embodiments, because the measurement reference position of the sample SAM may be properly determined and updated, the factors may be updated according to the measurement reference position of the sample SAM, and as a result, reliability of characterization analysis of the sample SAM may be further increased.

In one or more embodiments, the measurement reference position of the sample SAM, specifically the first position P1, may be determined based on the peak intensities of the Raman spectra obtained at various positions. For instance, by comparing the peak intensities PI1, P12, and P13 of the Raman spectra RAM1, RAM2, and RAM3, it can be concluded that the first Raman spectrum RAM1, measured at the first position P1, has the greatest peak intensity. Consequently, P1 is identified as the measurement reference position. Once this reference position is established, various factors for calculating the Raman spectrum, such as the intensity of the light L, the application time of the light L, and the number of light applications, can be adjusted accordingly. These adjustments ensure that the analysis is tailored to the specific position of the sample SAM, thereby enhancing the reliability of the characterization analysis.

Referring to FIGS. 4 to 7 in conjunction with FIG. 1, when the sample is arranged at the measurement reference position, applying the light to the sample (S280) may be performed.

In this step (e.g., act or task) S280, when the sample SAM is arranged at the measurement reference position (that is, the first position), the light L may be applied. As described herein, in order to analyze a characteristic of the first analysis target area A1 of the sample SAM, the Raman spectrum obtained based on the applied light L May generally have a relatively large or great value.

Referring to FIGS. 4 to 7 in conjunction with FIG. 1, analyzing the characteristic of the sample based on the Raman scattered light (S400) may be performed.

In this step (e.g., act or task) S400, based on the Raman scattered light output in response to the light L applied to the sample SAM arranged at the measurement reference position, the characteristic of the sample SAM in the first analysis target area A1 may be analyzed. As described herein, because the Raman spectrum for the light L for analyzing the first analysis target area A1 generally has the relatively large or great value, analysis reliability of the characteristic of the analyzed sample SAM may be increased.

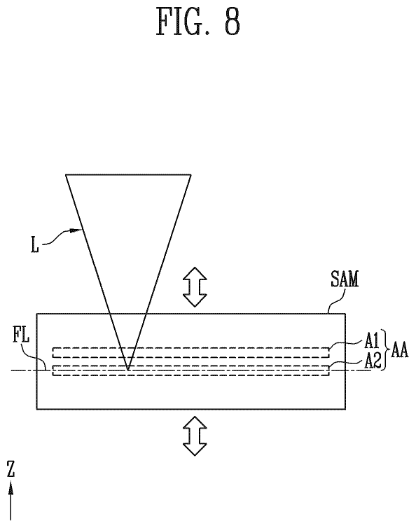

Referring to FIG. 8, after the characteristic of the sample SAM for the first analysis target area A1 is analyzed, the unit analysis step (e.g., act or task) for analyzing the characteristic of the sample SAM for the second analysis target area A2 UT may be further performed. The unit analysis step (e.g., act or task) UT for analyzing the characteristic of the sample SAM for the second analysis target area A2 may be performed substantially equal to the unit analysis step (e.g., act or task) UT for analyzing the characteristic of the sample SAM for the first analysis target area A1 as described herein. Accordingly, the Raman spectra for the second analysis target area A2 may be measured, the Raman spectrum having the greatest peak intensity among the Raman spectra may be determined, and the measurement reference position of the sample SAM corresponding thereto may be determined (or updated). Ultimately, the measurement reference position of the sample SAM and different factors for measuring the Raman spectrum may be updated, and thus analysis reliability for the sample SAM may be improved. For example, after analyzing the characteristic of the sample (SAM) for the first target area (A1), the same unit analysis step may be applied to the second target area (A2). This involves measuring the Raman spectra for A2, determining the spectrum with the highest peak intensity, and updating the measurement reference position of the sample (SAM). By updating the measurement reference position and other factors for measuring the Raman spectrum, the reliability of the sample analysis may be improved.

In one or more embodiments, as described herein, the first and second analysis target areas A1 and A2 may be spaced and/or apart (e.g., spaced apart or separated) along the depth direction of the sample SAM, which is the adjustment direction of the sample SAM, and thus a risk that the light intensity is to be distorted as the light L is applied to the sample SAM may be reduced.

Ultimately, according to one or more embodiments, the position of the sample SAM and the factors for measuring the Raman spectrum may be tracked and updated during a process procedure, and the sample analysis method using the Raman spectroscopy with significantly improved measurement reliability may be provided.

For example, as described herein, the first and second analysis target areas (A1 and A2) may be spaced apart along the depth direction of the sample (SAM), which is the adjustment direction. This spacing reduces the risk of light intensity distortion when light (L) is applied to the sample (SAM). For example, by tracking and updating the position of the sample (SAM) and the factors for measuring the Raman spectrum during the process, the method provides significantly improved measurement reliability in sample analysis using Raman spectroscopy.

### Electronic Device

Hereinafter, an electronic device 1000 including a display device comprising a light emitting diode (e.g., a light emitting diode sample) analyzed by the sample analysis method using the Raman spectroscopy in accordance with one or more embodiments, will be described.

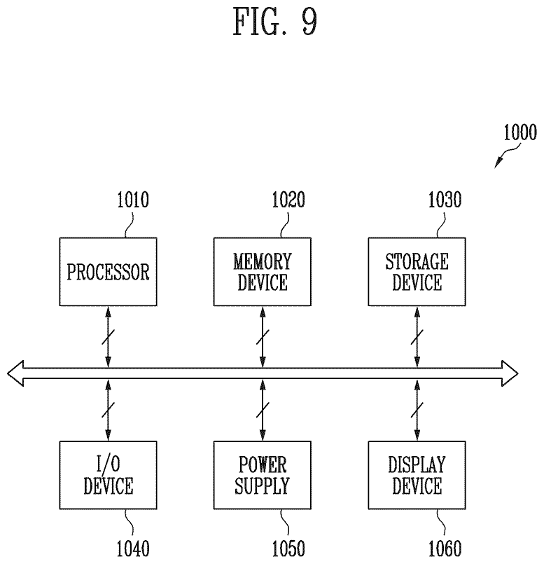

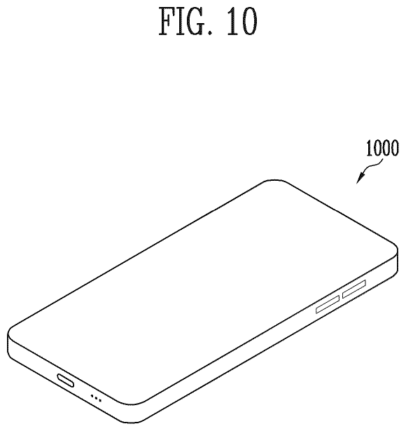

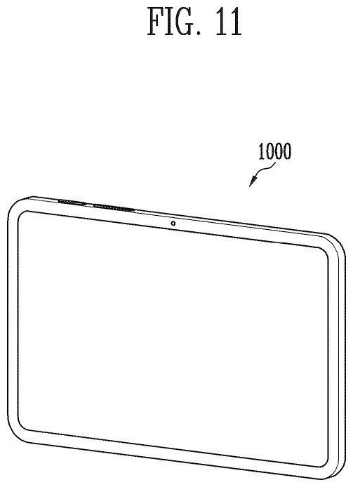

FIG. 9 is a schematic block diagram illustrating an electronic device 1000 including a display device in accordance with one or more embodiments. FIG. 10 is a schematic diagram illustrating an example where the electronic device 1000 of FIG. 9 is implemented as a smartphone. FIG. 11 is a schematic diagram illustrating an example where the electronic device 1000 of FIG. 9 is implemented as a tablet computer.

Referring to FIGS. 9 to 11, the electronic device 1000 may include a processor 1010, a memory device 1020, a storage device 1030, an input/output (I/O) device 1040, a power supply 1050, and a display device 1060. The display device 1060 may include a light emitting diode (e.g., a light emitting diode sample) analyzed by the sample analysis method using the Raman spectroscopy in accordance with one or more embodiments. The electronic device 1000 may further include one or more suitable ports for communication with a video card, a sound card, a memory card, a USB device, or other systems. In one or more embodiments, as illustrated in FIG. 10, the electronic device 1000 may be a smartphone. In one or more embodiments, as illustrated in FIG. 11, the electronic device 1000 may be a tablet computer. However, the aforementioned examples are illustrative, and the electronic device 1000 is not necessarily limited to the aforementioned examples. For example, the electronic device 1000 may be a cellular phone, a video phone, a smart pad, a smartwatch, a navigation device for vehicles, a computer monitor, a laptop computer, a head-mounted display device, and/or the like.

The processor 1010 may perform specific calculations or tasks. In an embodiment, the processor 1010 may include at least one of a central processing unit, an application processor, a graphic processing unit, a communication processor, an image signal processor, a controller, and/or the like. The processor 1010 may be connected to other components through an address bus, a control bus, a data bus, and/or the like. In an embodiment, the processor 1010 may be connected to an expansion bus such as a peripheral component interconnect (PCI) bus. In one or more embodiments, the processor 1010 may provide input image data to the display device 1060. Hence, the display device 1060 may display an image based on the input image data provided from the processor 1010.

The memory device 1020 may store data needed to perform the operation of the electronic device 1000. The memory device 1020 may function as a working memory and/or a buffer memory for the processor 1010. For example, the memory device 1020 may include one or more volatile memory devices such as a dynamic random access memory (DRAM) device, a static random access memory (SRAM) device, and a mobile DRAM device.

The storage device 1030 may store data in response to control signals or data from the processor 1010. The storage device 1030 may include one or more non-volatile storages to retain the data even when the electronic device 1000 is powered off. In one or more embodiments, the storage device 1030 may include a solid state drive (SSD), a hard disk drive (HDD), a CD-ROM, and/or the like.

The I/O device 1040 may include input devices such as a keyboard, a keypad, a touchpad, a touch screen, and a mouse, and output devices such as a speaker and a printer. In an embodiment, the display device 1060 may be integrated with the I/O device 1040.

The power supply 1050 may supply power needed to perform the operation of the electronic device 1000. For example, the power supply 1050 may include a power management integrated circuit (PMIC). In an embodiment, the power supply 1050 may supply power to the display device 1060.

The display device 1060 may display images in response to image data signals and/or control signals from the processor 1010. The display device 1060 may be connected to other components through the buses or other communication links.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

The Raman spectroscopy system, a display device or component thereof, a display manufacturing device, and/or any other relevant devices or components according to embodiments of the present disclosure described herein may be implemented utilizing any suitable hardware, firmware (e.g., an application-specific integrated circuit), software, or a combination of software, firmware, and hardware. For example, one or more suitable components of the Raman spectroscopy system may be formed on one integrated circuit (IC) chip or on separate IC chips. Further, one or more suitable components of the Raman spectroscopy system may be executed by one or more computing devices to perform one or more suitable functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of one or more suitable computing devices may be combined or integrated into a single computing device, or the functionality of a particular computing device may be distributed across one or more other computing devices without departing from the scope of the embodiments of the present disclosure.

In the context of the present application and unless otherwise defined, the terms “use,” “using,” and “used” may be considered synonymous with the terms “utilize,” “utilizing,” and “utilized,” respectively.

A person of ordinary skill in the art, in view of the present disclosure in its entirety, would appreciate that each suitable feature of the one or more suitable embodiments of the present disclosure may be combined or combined with each other, partially or entirely, and may be technically interlocked and operated in one or more suitable ways, and each embodiment may be implemented independently of each other or in conjunction with each other in any suitable manner unless otherwise stated or implied.

As described herein, although the present disclosure has been described with reference to one or more embodiments, those skilled in the art or those having a common knowledge in the art will understand that the present disclosure may be modified and changed without departing from the spirit and technical area of the present disclosure described in the following claims.

Therefore, the technical scope of the present disclosure should not be limited to the contents described in the preceding detailed description of the specification, but should be defined by the following claims and equivalents thereof.

What is claimed is:

1. A method comprising:
performing a plurality of unit analysis steps for analyzing a characteristic of a sample for an analysis target area, the plurality of unit analysis steps comprising:
changing a plurality of positions of the sample along an adjustment direction;
calculating a plurality of peak intensities, each peak intensity from a Raman spectrum at one of the plurality of positions, a Raman spectrum having a greatest peak intensity among the plurality of peak intensities being obtained when the sample is at a first position;
determining the first position as a measurement reference position of the sample;
applying a light to the sample arranged at the measurement reference position; and
analyzing the characteristic of the sample based on Raman scattered light generated as the light is provided to the sample,
wherein the method is a sample analysis method.

2. The method according to claim 1, wherein in the plurality of unit analysis steps, the measurement reference position is updated according to a position of the analysis target area in the sample.

3. The method according to claim 2, wherein in the plurality of unit analysis steps, as the measurement reference position is determined, a factor for obtaining the Raman spectrum is updated.

4. The method according to claim 3, wherein the factor comprises at least one selected from among an intensity of the light, an application time of the light, and a number of times the light is applied.

5. The method according to claim 1, wherein in the plurality of unit analysis steps, a position of the analysis target area for the light is tracked.

6. The method according to claim 1, wherein the characteristic comprises at least one selected from among a stress of the sample, a structure of the sample, and a phase of the sample.

7. The method according to claim 1, wherein the sample is a light emitting diode sample or an organic layer sample.

8. The method according to claim 1, wherein the sample is on a stage and changing the plurality of positions comprises changing a height of the stage, and wherein the adjustment direction is parallel to a direction in which the light is provided.

9. The method according to claim 1, wherein the adjustment direction is a depth direction of the sample based on a direction in which the light is provided.

10. The method according to claim 1, wherein the plurality of unit analysis steps comprises at least a first plurality of unit analysis steps:
the first plurality of unit analysis steps comprising analyzing a characteristic of the sample in a first analysis target area.

11. The method according to claim 10, wherein the plurality of unit analysis steps further comprises at least a second plurality of unit analysis steps:
the second plurality of unit analysis steps comprising analyzing a characteristic of the sample in a second analysis target area, and
wherein the first analysis target area and the second analysis target area are spaced apart from each other along the adjustment direction.

12. The method according to claim 11, wherein the second plurality of unit analysis steps is performed after the first plurality of unit analysis steps, and the measurement reference position is updated in the second plurality of unit analysis steps.

13. The method according to claim 1, wherein the changing of the plurality of positions comprises:
arranging the sample at the first position; and
arranging the sample at a second position different from the first position, wherein when the sample is at the first position, a first focus line of the light overlaps the analysis target area, and
when the sample is at the second position, a second focus line of the light is spaced apart from the first focus line.

14. The method according to claim 13, wherein a peak intensity of a Raman spectrum obtained at the second position is less than a peak intensity of a Raman spectrum obtained at the first position.

15. The method according to claim 13, wherein the changing of the plurality of positions further comprises arranging the sample at a third position different from the first position and the second position,
wherein at the third position, a third focus line of the light is spaced apart from the first focus line, and
the third focus line is between the first focus line and the second focus line.

16. A method comprising:
providing a light to a sample comprising a first analysis target area and a second analysis target area spaced apart from the first analysis target area in one direction; and
analyzing a characteristic of the sample based on Raman scattered light generated as the light is provided to the sample,
wherein the analyzing of the characteristic of the sample comprises:
a first plurality of unit analysis steps comprising analyzing the characteristic of the sample in the first analysis target area; and
a second plurality of unit analysis steps comprising analyzing the characteristic of the sample in the second analysis target area,
wherein both of the first plurality of unit analysis steps and the second plurality of unit analysis steps comprise changing a plurality of positions of the sample along the one direction, and
wherein the method is a sample analysis method.

17. The method according to claim 1, wherein the method comprises non-destructive analysis of the sample.

18. The method according to claim 16, wherein the method comprises non-destructive analysis of the sample.

19. An electronic device, comprising:
a processor configured to provide input image data;
a display device configured to display an image based on the input image data, the display device including a light emitting diode analyzed by the sample analysis according to the method of claim 1; and
a power supply configured to supply power to the display device.
